(19) United States
(12) Patent Application Publication
(10) Pub. No.: US 2013/0014625 A1
(43) Pub. Date: Jan. 17, 2013

(54) ELECTRODE PLATE MANUFACTURING DEVICE

(71) Applicants: Hiroaki Yotsumoto, Tokyo (JP); Yoshinori Matsunaga, Nagasaki-shi (JP); Akira Tsuji, Nagasaki-shi (JP)

(72) Inventors: Hiroaki Yotsumoto, Tokyo (JP); Yoshinori Matsunaga, Nagasaki-shi (JP); Akira Tsuji, Nagasaki-shi (JP)

(73) Assignee: MITSUBISHI HEAVY INDUSTRIES, LTD., Tokyo (JP)

(21) Appl. No.: 13/636,502

(22) PCT Filed: Mar. 25, 2011
(86) PCT No.: PCT/JP2011/057334

§ 371 Date: Sep. 21, 2012

(30) Foreign Application Priority Data
Mar. 26, 2010 (JP) 2010-073170

(51) Int. Cl. B26F 1/40

(52) U.S. Cl. 83/202

(57) ABSTRACT

An electrode plate manufacturing device of the invention includes: an original plate support portion that supports an original plate of an electrode plate; a first pressing portion; a frame-shaped punching-out blade; a support substrate; and a driving portion, wherein the first pressing portion is disposed at in an area inside of the frame shape of the punching-out blade and with a predetermined gap from the punching-out blade, and when the support substrate advances toward the original plate support portion, the first pressing portion presses the original plate and the punching-out blade cuts the original plate in accordance with the frame shape.

### TECHNICAL FIELD

The present invention relates to an electrode plate manufacturing device.

Priority is claimed on Japanese Patent Application No. 2010-073170, filed on Mar. 26, 2010, the content of which is incorporated herein by reference.

### BACKGROUND ART

Hitherto, an electrical cell has been used as a power source of various electrical devices. A secondary battery as an electrical cell that may be repeatedly charged and discharged is used as a power buffer such as a power generating device in addition to a power source. As a configuration example of the electrical cell, there are two examples of a stacked-type in which a plurality of positive electrode plates and a plurality of negative electrode plates are sequentially stacked with separators interposed between them and a wound-type in which one positive electrode plate and one negative electrode plate are wound with a separator interposed between them. In both types, in the electrode plate (the positive electrode plate or the negative electrode plate), a surface of a current collector is coated with an electrode active material.

Among them, as an example of a method of manufacturing a stack-type electrode plate, a method disclosed in Patent Document 1 may be exemplified.

In Patent Document 1, the surface of the current collector is coated with the electrode active material to form an original plate, and thereafter the original plate is punched out by using a punching-out die (Thomson type) to manufacture a substantially rectangular electrode plate. The punching-out die has a configuration in which a band-shaped punching-out blade (Thomson blade) is perpendicularly fixed to a support substrate and a pressing member formed of an elastic material is attached to the punching-out blade to cover the punching-out blade. When a substantially rectangular electrode plate is punched out, the punching-out blade also has the same shape. In the state where the punching-out die does not press the original plate, the punching-out blade is buried by the pressing member, and the punching-out blade inside the pressing member is not seen from the outside.

When the punching-out die is pressed against the original plate supported on a support table, the pressing member is compressed and deformed, so that the punching-out blade protrudes from the support substrate. The original plate is pressed toward the support table by a pressing force of the pressing member, and is cut by the punching-out blade, so that the electrode plate is formed.

In PTL 1, when the punching-out blade has a shape of a single edged blade, no load is applied to the cutting surface of the electrode plate. For this reason, burrs or cracks hardly occur in the electrode active material.

### CITATION LIST

### Patent Document

[Patent Document 1] Japanese Patent Application, Laid-Open No. 2003-100288

### SUMMARY OF INVENTION

### Technical Problem

However, even when the technique of Patent Document 1 is used, the electrode active material may be peeled off and fall off, that is, become separated from the current collecting material in the peripheral edge of the electrode plate. Therefore, there is a problem in that the manufacturing yield is not good.

The invention is made in view of the above-described circumstances, and it is an object of the invention to provide an electrode plate manufacturing device capable of improving manufacturing yield by preventing, as much as possible, separation of an electrode active material when punching-out an electrode plate.

### Solution to Problem

The invention adopts the following means in order to attain the above-described object.

An electrode plate manufacturing device of the invention includes: an original plate support portion that supports an original plate of an electrode plate coated with an electrode active material; a first pressing portion; a frame-shaped punching-out blade; a support substrate, which is disposed to face the original plate support portion, having the first pressing portion and the punching-out blade fixed thereto; and a driving portion that drives the support substrate to be movable forward and backward with respect to the original plate support portion, wherein the first pressing portion is disposed in an area inside of the frame shape of the punching-out blade and with a predetermined gap from a punching-out blade cutting the electrode active material, and wherein when the support substrate is advanced toward the original plate support portion by the driving portion, the first pressing portion presses the original plate and the punching-out blade cuts the original plate in accordance with the frame shape.

Since the first pressing portion is disposed with a predetermined gap from the punching-out blade cutting the electrode active material, the original plate present at the gap is not pressed by the first pressing portion. For this reason, the deformation of the original plate is permitted at the gap. On the other hand, since the first pressing portion presses and fixes the original plate portion becoming the electrode plate, it is possible to highly precisely perform cutting without a position gap, that is, punching-out when cutting the original plate using the punching-out blade despite a predetermined gap. Therefore, it is possible to prevent the electrode active material from being separated from the current collector and highly precisely manufacture the electrode plate.

### Advantageous Effects of Invention

According to the electrode plate manufacturing device of the invention, it is possible to prevent the electrode active material from being separated from the peripheral edge portion of the electrode plate and improve the manufacturing yield.

### BRIEF DESCRIPTION OF DRAWINGS

FIG. 1 is a perspective view schematically illustrating a configuration example of an electrical cell.

FIG. 2(a) is a plan view illustrating an electrode plate, and FIG. 2(b) is a cross-sectional view taken along the line A-A′ of FIG. 2(a).

FIG. 3 is a flowchart schematically illustrating a method of manufacturing the electrical cell.

FIG. 4 is a perspective view illustrating a schematic configuration of an electrode plate manufacturing device.

FIG. 5 is a perspective view illustrating a driving system when it is seen through an original plate support portion from the downside.

FIG. 6(a) is a plan view illustrating the electrode plate manufacturing device, and FIG. 6(b) is a side view illustrating the electrode plate manufacturing device.

FIG. 7(a) is a plan view illustrating a punching-out die, and FIG. 7(b) is a cross-sectional view taken along the line B-B′ of FIG. 7(a).

FIGS. 8(a) to 8(c) are cross-sectional views illustrating a process of punching-out an original plate.

FIG. 9 is a diagram illustrating a force acting on a cutting portion during the punching-out process.

FIG. 10(a) is a plan view illustrating a punching-out die of a first modified example, and FIG. 10(b) is a cross-sectional view illustrating a punching-out blade of a second modified example.

### DESCRIPTION OF EMBODIMENTS

Hereinafter, an embodiment of the invention will be described by referring to the drawings. In the drawings to be used for description, the dimensions or the scales of the structures of the drawings may be different from those of the real structure in order to easily understand characteristic points. It is not the case that all the components described in the embodiment are essentially necessary for the invention. The same reference numerals are given to the same components of the drawings, and the detailed description thereof will not be repeated. Ahead of the description of an electrode plate manufacturing device according to the invention, first, a configuration example of an electrical cell and an example of a method of manufacturing the electrical cell will be described.

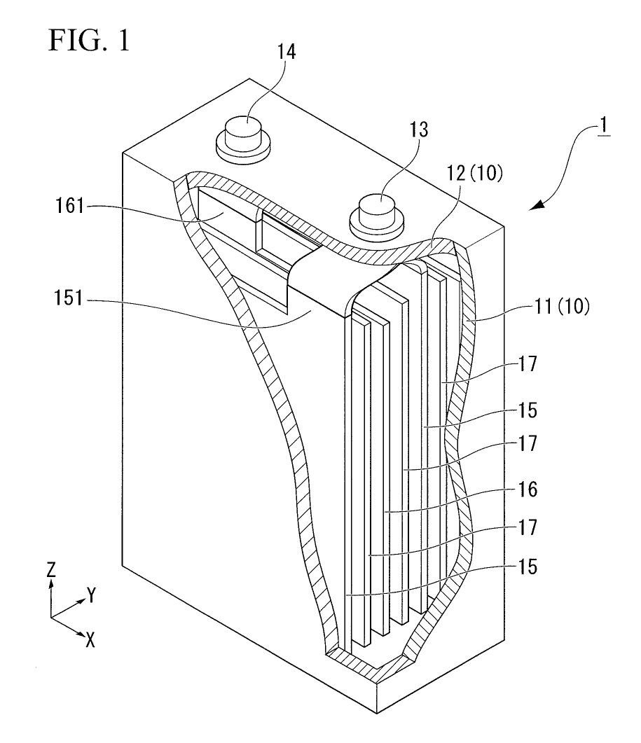

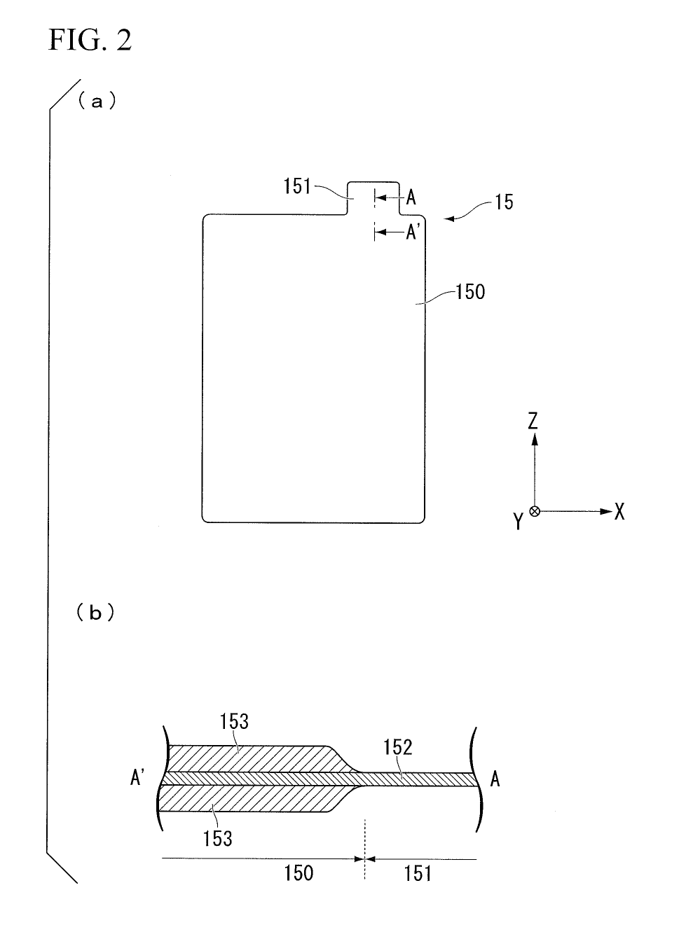

FIG. 1 is an exploded perspective view illustrating a configuration example of the electrical cell, FIG. 2(a) is a plan view illustrating an example of an electrode plate, and FIG. 2(b) is a cross-sectional view taken along the line A-A′ of FIG. 2(a).

As shown in FIG. 1, an electrical cell 1 includes a battery casing 10 that stores an electrolytic solution therein. The electrical cell 1 is, for example, a lithium ion secondary battery. Since the electrode manufacturing device of the embodiment may be applied to any electrical cell that is manufactured by punching-out an electrode plate, the electrode manufacturing device is not limited by the shape or the material of the battery casing. Further, the electrode manufacturing device of the embodiment is not limited to any type of battery, and may be applied to, for example, a primary battery.

The battery casing 10 of the example is an aluminum hollow casing, and the outer shape thereof is a substantially prismatic column shape (substantially rectangular parallelepiped shape) along the XYZ axes of FIG. 1. The battery casing 10 includes a casing body 11 that has an opening and a cover 12 that blocks the opening and is bonded to the casing body 11. The opening of the casing body 11 and the cover 12 are formed in a shape in which they may seal each other.

The cover 12 is provided with electrode terminals 13 and 14. The electrode terminal 13 is a positive electrode terminal, and the electrode terminal 14 is a negative electrode terminal. The battery casing 10 contains a plurality of electrode plates 15 and 16 and a plurality of separators 17. The electrode plate 15 is a positive electrode plate, and the electrode plate 16 is a negative electrode plate. The plurality of electrode plates 15 and 16 is repeatedly arranged so that the positive electrode plate and the negative electrode plate are alternately arranged. Furthermore, an electrode active material of the electrode plate 15 serving as the positive electrode plate is, for example, a three-dimensional material, LiNixCoyMnzO2 (x+y+z=1), and an electrode active material of the electrode plate 16 serving as the negative electrode plate is, for example, a carbon material (artificial graphite or the like).

The separator 17 is disposed to be interposed between the pair of electrode plates 15 and 16, and the electrode plates 15 and 16 do not directly contact each other. The separator 17 is formed of a porous insulating material, and allows an electrolyte component such as a lithium ion to pass therethrough. In practice, a stacked body is formed by laminating the plurality of positive electrode plates, the plurality of negative electrode plates, and the plurality of separators. The electrical cell 1 has a structure in which the stacked body is contained inside the battery casing 10. An electrolytic solution is stored inside the battery casing 10 so as to contact the electrode plates 15 and 16.

FIG. 2(a) illustrates the electrode plate 15 disposed on the XZ plane. The electrode plate 15 includes a base portion 150 and an electrode tab 151. The planar shape of the base portion 150 is, for example, a substantially rectangular shape of which the corner of the rectangle is round. The electrode tab 151 is formed at the base end corresponding to one side of the base portion 150 so as to protrude toward the outside of the base portion 150. The protruding direction of the electrode tab 151 is, for example, the Z direction which is a direction substantially perpendicular to one side (hereinafter, referred to as a tab installation side) having a base end and following the main surface of the base portion 150. The electrode tab 151 is formed so as to be biased to one side of the tab installation side. The electrode tabs 151 of the plurality of electrode plates 15 are integrated to be electrically connected to the electrode terminal 13.

FIG. 2(b) is a cross-sectional view taken along the line A-A′ of the electrode plate 15 shown in FIG. 2(a). The electrode plate 15 includes a current collector 152 and an electrode active material 153. The current collector 152 is, for example, a sheet-like conductive foil formed of aluminum or copper and having a thickness of several tens of μm or so (for example, 20 μm or so). The electrode active material 153 is formed of a material according to the type of the electrolytic solution, and is coated on both surfaces of the current collector 152. The thickness of the electrode active material 153 is several tens of μm to several hundreds of μm or so (for example, 100 μm or so).

The electrode plate 15 includes the base portion 150 which is coated with the electrode active material 153 and the electrode tab 151 which is not coated with the electrode active material 153. As described below, the electrode tab 151 is formed by punching-out the current collector 152.

As described above, in the electrode plate 16, different materials form the electrode active material, and the dimension of the base portion is formed to be larger than that of the electrode plate 15, but the structure or the shape thereof is the same as that of the electrode plate 15. As shown in FIG. 1, an electrode tab 161 of the electrode plate 16 is disposed so as not to overlap the electrode tab 151 of the electrode plate 15. The electrode tabs 161 of the plurality of electrode plates 16 are integrated to be electrically connected to the electrode terminal 14.

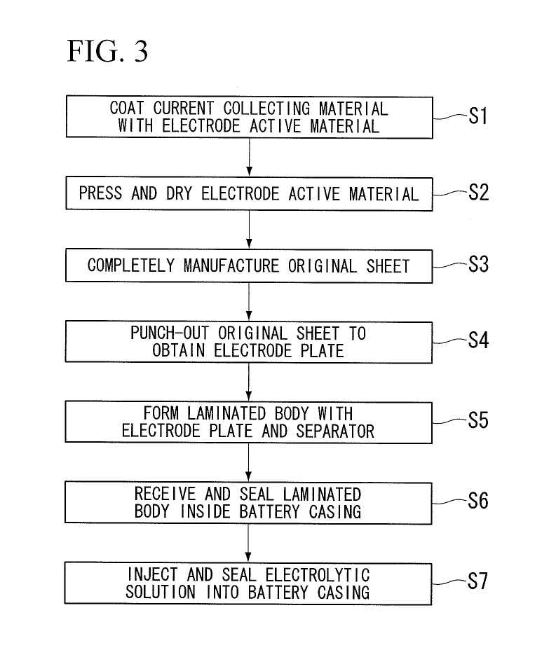

FIG. 3 is a flowchart schematically illustrating an example of a method of manufacturing the electrical cell.

In order to manufacture the electrical cell 1, in step S1, both surfaces of sheet-like current collectors for a positive electrode and a negative electrode are respectively coated with the electrode active materials corresponding to each electrode. Subsequently, in step S2, the electrode active material after coating is pressed against the current collector through a roll press, and then the electrode active material is dried. Accordingly, in step S3, original plates of the electrode plates for a positive electrode and a negative electrode are respectively completed.

Then, in step S4, the electrode plates are respectively punched out from the original plates, so that the electrode plates to be used as a positive electrode and a negative electrode are completed. In this step, the electrode plate manufacturing device of the embodiment is used.

Subsequently, in step S5, a stacked body is formed by stacking the positive electrode plate and the negative electrode plate with the separator interposed between them.

Furthermore, in step S6, the stacked body is contained and sealed inside the battery casing. At this time, the positive electrode plate is electrically connected to the positive electrode terminal, and the negative electrode plate is connected to the negative electrode terminal. Then, the cover is bonded to the casing body by welding or the like.

Subsequently, in step S7, an electrolytic solution is injected into the battery casing, and the injection hole is sealed, thereby obtaining the electrical cell.

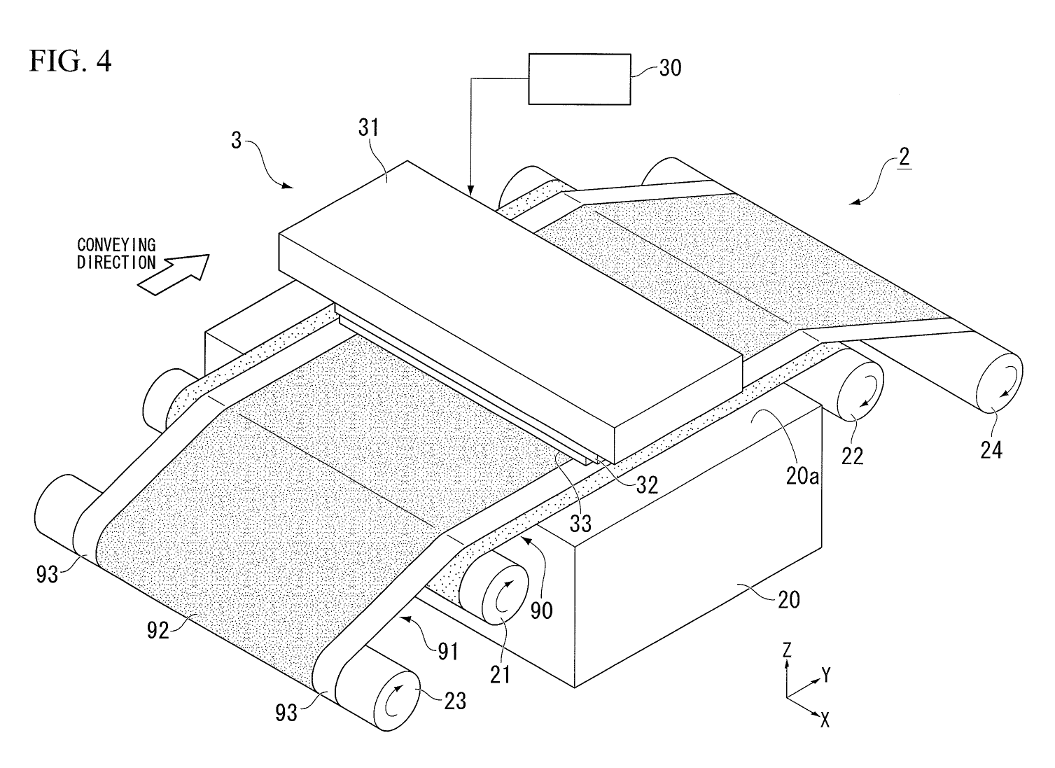

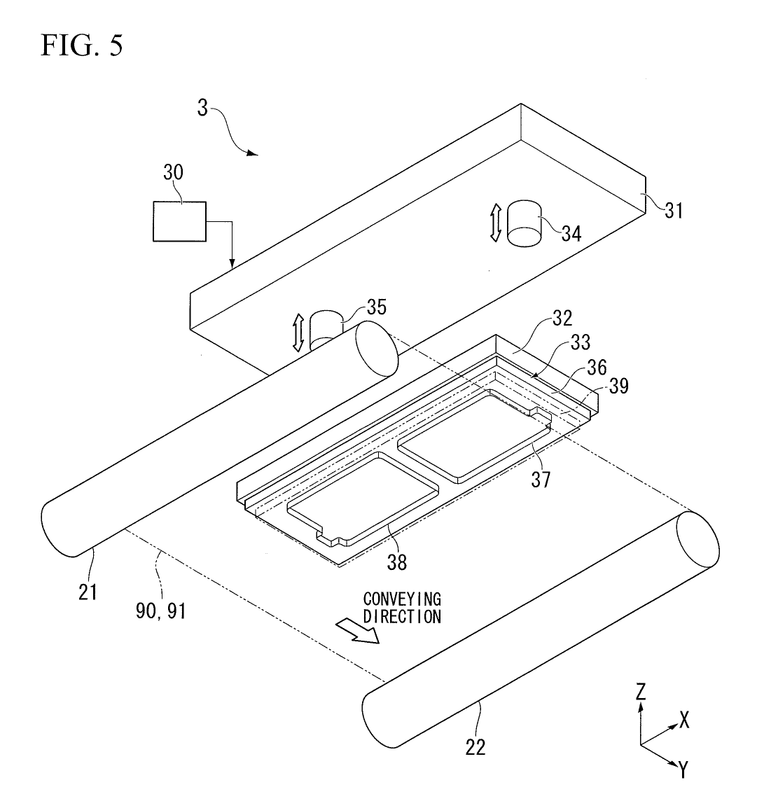

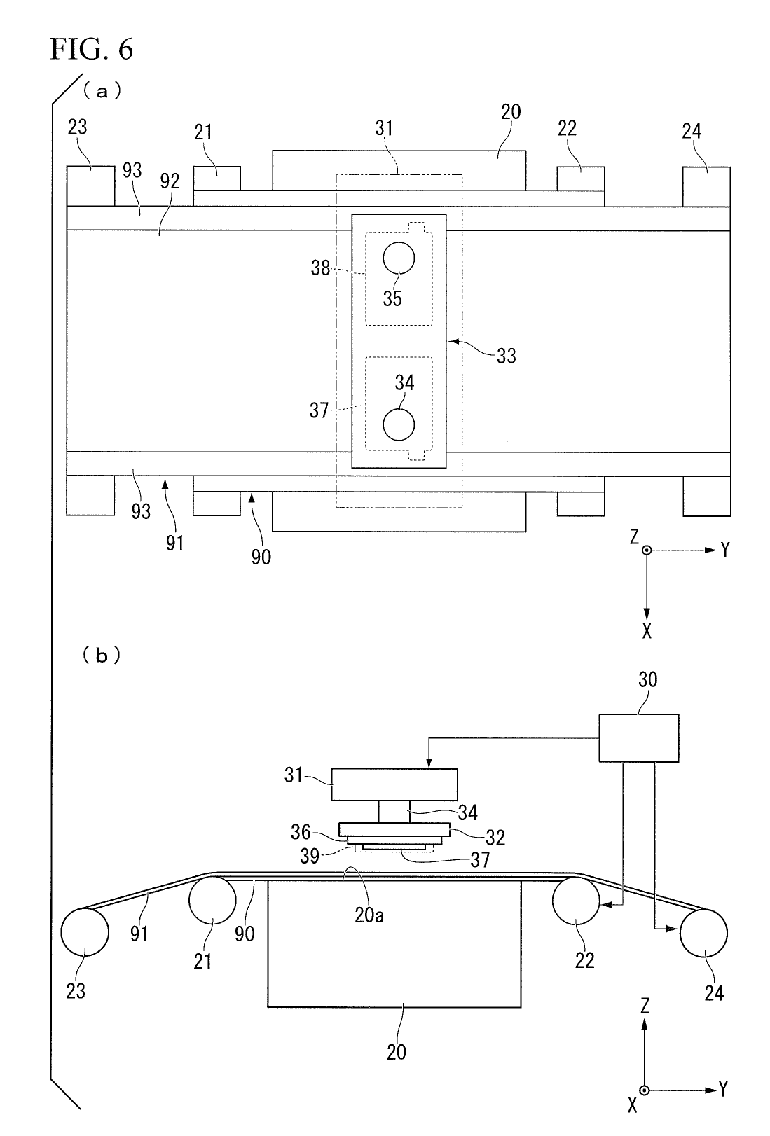

On the basis of this, an embodiment of the electrode plate manufacturing device punching-out the electrode plate will be described by referring to FIGS. 4, 5, and 6. FIG. 4 is a perspective view illustrating a schematic configuration of the embodiment of the electrode plate manufacturing device, and FIG. 5 is an exploded perspective view illustrating a driving system when it is seen through an original plate support portion from the downside. FIG. 6 is a plan view and a side view of the electrode plate manufacturing device. The XYZ axes described from FIG. 4 are not related to the XYZ axes described in FIGS. 1 and 2.

As shown in FIG. 4, a resinous protective sheet 90 is disposed on a top surface 20a of an original plate support portion 20, and an original plate 91 for a positive electrode or a negative electrode is disposed on the protective sheet 90. The protective sheet 90 is conveyed by conveying rollers 21 and 22, and the original plate 91 is conveyed by conveying rollers 23 and 24. The protective sheet 90 and the original plate 91 are conveyed in a synchronized manner so as to have the same speed and the same step operation. The driving of the conveying rollers 21 to 24 is controlled by a control portion 30 so as to be synchronized with the operation of the driving portion 31.

As shown in FIGS. 4 and 5, the driving system 3 includes a driving portion 31, support columns 34 and 35 of which one-side ends are respectively disposed on the same surface of the driving portion 31 and which move in the vertical direction using the driving portion 31, a holding portion 32 which is connected to the other-side ends of the support columns 34 and 35 and holds a support substrate 36, and a punching-out die 33 which is fixed to a surface facing the top surface 20a of the original plate support portion 20 in a surface of the support substrate 36.

A punching-out blade 37 and pressing unit 39 are disposed on the punching-out die 33.

The vertical movement is controlled by the control portion 30.

The electrode plate manufacturing device 2 is schematically operated as below.

The control portion 30 conveys the original plate 91 and the protective sheet 90 by a predetermined conveying width, and stops the conveying rollers 21 to 24. That is, the control portion 30 intermittently operates the conveying rollers 21 to 24.

After the conveying rollers 21 to 24 are stopped, the control portion 30 controls the driving portion 31, and the driving portion 31 moves the holding portion 32 in the vertical direction (that is, drives the holding portion in a reciprocating manner). First, the holding portion 32 is moved downward toward the top surface 20a of the original plate support portion 20, so that the punching-out die 33 is pressed against the original plate 91 conveyed to the top surface 20a. Then, the punching-out blades 37 and 38 penetrate and cut the original plate 91, and the portions surrounded by the punching-out blades 37 and 38 are respectively punched out as the electrode plates from the original plate 91. Next, the holding portion 32 is moved upward, so that the punching-out die 33 is separated from the original plate 91 and is retracted upward. Then, the conveying rollers 21 to 24 are controlled to intermittently operate the control portion 30, so that the protective sheet 90 and the original plate 91 are conveyed by a predetermined conveying width in the Y direction. Accordingly, the original plate 91 of the punched-out portion is collected by a device (not shown) collecting the electrode plate, on the other hand, the original plate 91 of the portion which is not punched out is conveyed in the Y direction. The electrode plate punching-out device 2 repeats the above-described operation, so that the original plate 91 is repeatedly punched out.

Furthermore, it is designed so that the punching-out blades 37 and 38 penetrate the original plate 91, but do not penetrate the protective sheet 90 when the holding portion 32 is moved downward. For this reason, it is possible to prevent damage in which the punching-out blades 37 and 38 contact the original plate support portion 20 so that the blades come off.

As shown in FIG. 6(b), the conveying rollers 23 and 24 conveying the original plate 91 are disposed below the conveying rollers 21 and 22 (in the −Z direction). Since it is possible to generate tension in the original plate 91 and prevent wrinkles from being formed in the original plate 91 due to such an arrangement of the conveying rollers, it is possible to appropriately punch-out the electrode plate.

As shown in FIG. 6(a), the original plate 91 is provided with a formation region 92 where the electrode active material is applied and a non-formation region 93 where the electrode active material is not applied. The non-formation region 93 is formed at both ends of the original plate 91 in the lateral direction (X direction).

The punching-out die 33 has two punching-out blades 37 and 38, and both have the same shape. The punching-out blades 37 and 38 are disposed so as to simultaneously punch-out two electrode plates in total in a manner such that the electrode tab of one electrode plate is punched out at the non-formation region 93 of one end of the original plate 91 and the electrode tab of the other electrode plate is punched out at the non-formation region 93 of the other end of the original plate 91. Specifically, the punching-out blades 37 and 38 are provided to be symmetrical with respect to an imaginary line pulled in the Y direction as the conveying direction from the center of the formation region 92 in the X direction.

Hereinafter, the punching-out blade 37 and the pressing unit 39 will be specifically described. The relationship between the punching-out blade 38 and the pressing unit 39 is the same as the relationship between the punching-out blade 37 and the pressing unit 39.

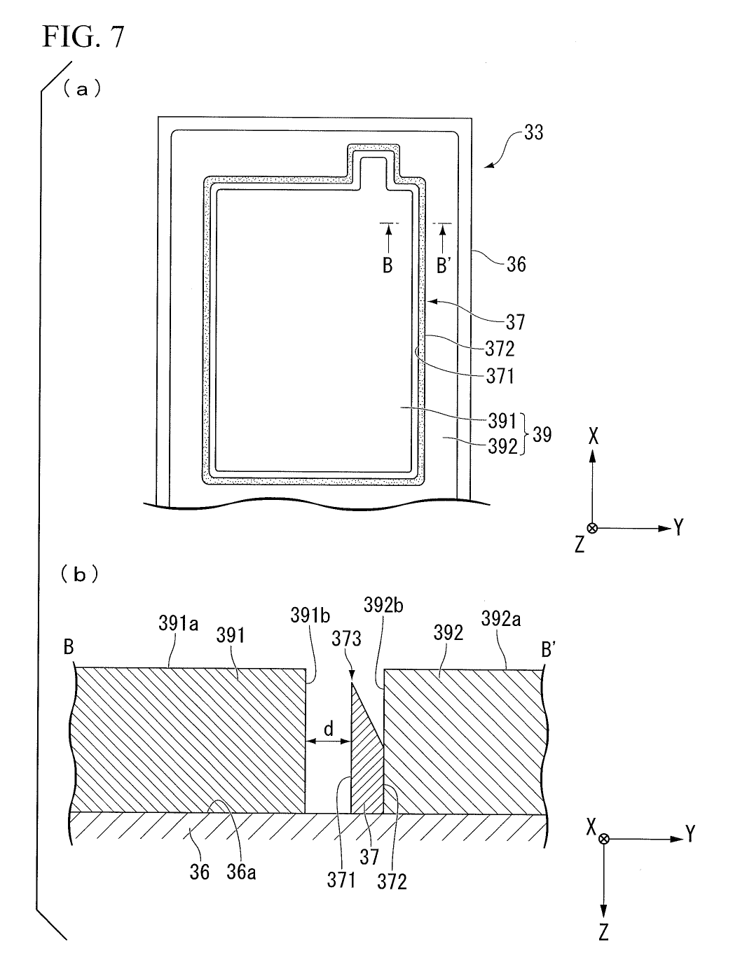

FIG. 7(a) is a plan view of the punching-out die 33 when the surface facing the support substrate is seen from the upside, and FIG. 7(b) is a cross-sectional view taken along the line B-B′ of FIG. 7(a). As shown in FIGS. 7(a) and 7(b), the shape (hereinafter, referred to as a planar shape) of the punching-out blade 37 when an arrangement surface 36a for disposing and fixing the punching-out blade 37 and the pressing unit 39 in the surface of the support substrate 36 is seen from above is formed in a closed shape (frame shape), and is substantially the same as the outline of the electrode plate. The punching-out blade 37 is a single edged blade, and a band-shaped body (sheet-like body) provided with the blade edge is bent to have the frame shape. The punching-out blade 37 is buried in the support substrate 36 so that the blade edge is substantially perpendicular to the arrangement surface 36a. The sheet thickness of the band-shaped body is, for example, 0.5 mm to 2.0 mm or so.

Specifically, an inner peripheral surface (one surface) 371 of the punching-out blade 37 is substantially perpendicular to the arrangement surface 36a (an angle with respect to the direction perpendicular to the arrangement surface 36a is substantially 0°), and the front end of the inner peripheral surface 371 is formed as a blade edge 373. In an outer peripheral surface (the other surface) 372 of the punching-out blade 37, a portion toward the blade edge 373 is inclined by 30° with respect to the direction perpendicular to the arrangement surface 36a.

As shown in FIGS. 7(a) and 7(b), the pressing unit 39 is a member that presses the original plate 91 toward the top surface 20a of the original plate support portion 20 when punching-out the original plate 91. The pressing unit 39 includes a first pressing portion 391 and a second pressing portion 392. When the arrangement surface 36a is seen from the upside, the first pressing portion 391 is provided at the inside of the frame shape, that is, the inside (one surface side) of the inner peripheral surface 371 with respect to the punching-out blade 37, and the second pressing portion 392 is provided at the outside (the other surface side) of the outer peripheral surface 372.

The first pressing portion 391 and the second pressing portion 392 are formed of, for example, an elastic body such as rubber or sponge. Here, the first pressing portion 391 and the second pressing portion 392 are formed of the same material. As the pressing unit 39, a member with a pressing surface may be biased toward the original plate support portion by a spring or the like.

The dimension (thickness) of the first pressing portion 391 and the second pressing portion 392 in the direction perpendicular to the arrangement surface 36a (the −Z direction of FIG. 7(b)) is set so that a surface 391a of the first pressing portion 391 and a surface 392a of the second pressing portion 392 protrude more than the blade edge 373. Here, the surface 391a and the surface 392a are located at the same position in the Z direction.

A gap d of the first pressing portion 391 is provided so that a side surface 391b thereof is distant from the inner peripheral surface 371 of the frame-shaped punching-out blade. As shown in FIG. 7(a), since the first pressing portion is distant by the gap d from the inner peripheral surface 371 of the frame-shaped punching-out blade, the shape of the first pressing portion 391 is substantially the same as the contracted shape of the electrode plate.

Of course, as described below, the gap d is provided to prevent the separation of the electrode active material 153 coated on the original plate 91. Therefore, since no separation actually occurs in the portion of the electrode tab 151 only formed of the metallic current collector 152, a configuration may be adopted in which the gap is not provided between the first pressing portion 391 and the inner peripheral surface of the punching-out blade cutting the current collector 152 in order to form the electrode tab 151 in the frame-shaped punching-out blade, and the gap d is only provided between the first pressing portion 391 and the inner peripheral surface 371 of the punching-out blade cutting the electrode active material 153.

The gap d is set in accordance with the material of forming the original plate 91 or the plate thickness, but here is set to about 5 mm.

The second pressing portion 392 is provided so that a side surface 392b comes into contact with the outer peripheral surface 372. When the side surface 392b comes into contact with the outer peripheral surface 372, the original plate 91 may be pressed around the punching-out blade 37 during the punching-out process, and a positional deviation between the original plate 91 and the punching-out blade 37 may be effectively prevented.

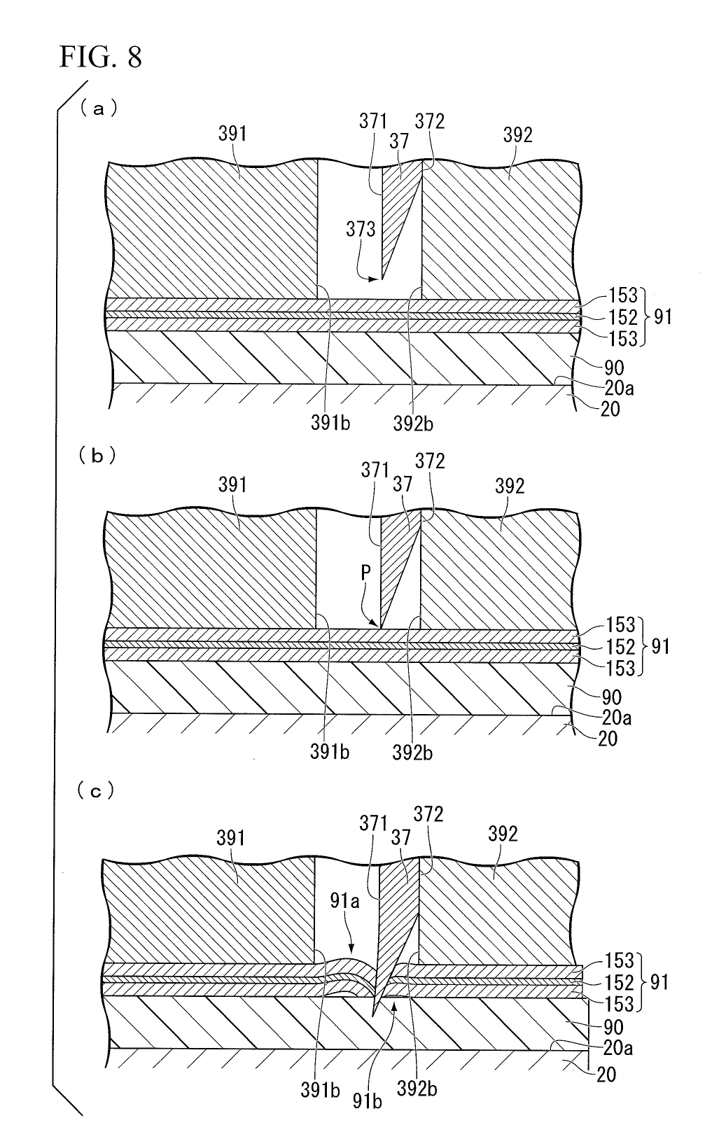

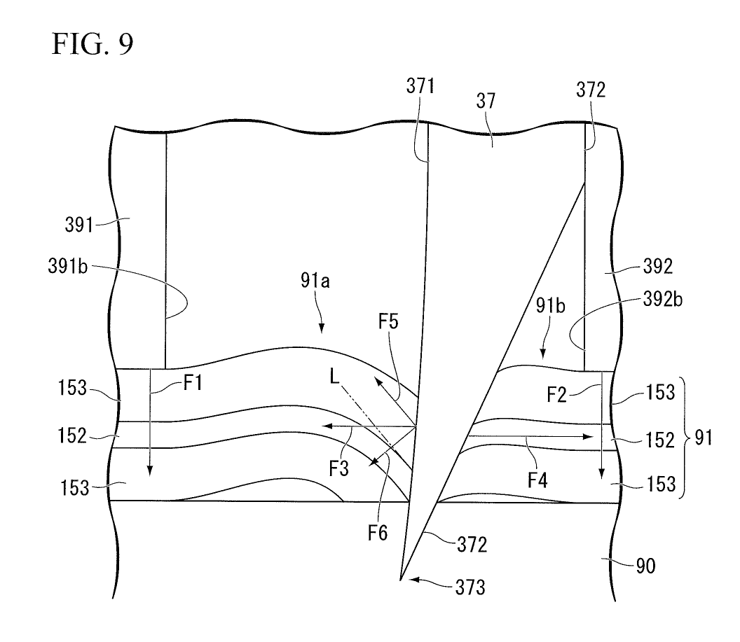

Next, a process of punching-out the original plate 91 using the punching-out die 33 will be described by referring to FIGS. 8 and 9. FIGS. 8(a) to 8(c) are cross-sectional views magnifying the original plate and the punching-out blade during the punching-out process, and FIG. 9 is a diagram illustrating a force acting on the cutting portion during the punching-out process.

In order to punch-out the original plate 91, as described above, the control portion 30 moves the support substrate 36 downward, so that the surface 391a of the first pressing portion and the surface 392a of the second pressing portion contact the electrode active material 153 as the surface different from the surface contacting the protective sheet 90 in the surface of the original plate 91 as shown in FIG. 8(a). In this step, the blade edge 373 does not contact the electrode active material 153 located at one surface layer of the original plate 91.

When the control portion 30 moves the support substrate 36 further downward, as shown in FIG. 8(b), the first pressing portion 391 and the second pressing portion 392 are pressed toward the original plate support portion 20 to be compressed and deformed, and the blade edge 373 contacts the original plate 91. The original plate 91 is pressed toward the original plate support portion 20 by the pressing force of the first pressing portion 391 and the second pressing portion 392. Accordingly, the relative position between the original plate 91 and the punching-out blade 37 is regulated, and the blade edge 373 may contact a predetermined position P of the original plate 91.

When the control portion 30 moves the support substrate 36 further downward, as shown in FIG. 8(c), the blade edge 373 penetrates the original plate 91 so as to cut the original plate 91. The original plate 91 of the inner portion surrounded by the punching-out blade 37 is punched out as the electrode plate. Subsequently, when the control portion 30 moves the support substrate 36 upward, the punching-out blade 37 moves away from the original plate 91 with a pressing force for the electrode plate punched out by the first pressing portion 391 and a pressing force for the other original plate 91 other than the electrode plate punched out by the second pressing portion 392, thereby preventing the punched-out electrode plate from moving with the punching-out blade 37.

However, a cutting portion 91a inside the punching-out blade 37 and a cutting portion 91b outside the punching-out blade 37 may be pressed and widened in the direction moving away from each other by the plate thickness of the punching-out blade 37 intruding into the original plate 91.

As shown in FIG. 9, the position of the original plate 91 of the portion coming into contact with the second pressing portion 392 is regulated while being pressed by the pressing force F2 of the second pressing portion 392. The cutting portion 91b is compressed in the direction along the surface of the original plate 91 while receiving the compressing force F4 exerted toward the outside of the punching-out blade 37 from the outer peripheral surface 372.

However, the deformation range of the cutting portion 91b in the direction along the surface of the original plate 91 is restricted since the position of the portion coming into contact with the second pressing portion 392 is regulated to be a position directly below the outer peripheral surface 372, that is, a position near the blade edge 373. Since the distortion of the cutting portion 91b is not easily alleviated, a compressing force F4 acts in a focused manner on the cutting portion 91b. Then, since the current collector 152 and the electrode active material 153 have different materials and different mechanical characteristics, the current collector 152 and the electrode active material 153 may not be deformed while being interlocked with each other, and a shear force acts in the direction along the boundary surface between the current collector 152 and the electrode active material 153 (hereinafter, simply referred to as a boundary surface).

Since the shear force of the boundary surface is a force causing a deviation between the current collector 911 and the electrode active materials 912 and 913, the electrode active material 153 is easily separated from the current collector 152. However, since the cutting portion 91b is the portion outside the punching-out blade 37 and the portion not forming the electrode plate, no problems arise even when the electrode active material is separated from the cutting portion 91b.

On the other hand, in the cutting portion 91a as the portion forming the electrode plate, the electrode active material 153 is not easily separated therefrom as described below unlike the cutting portion 91b. The position of the original plate 91 coming into contact with the first pressing portion 391 is regulated while being pressed by a pressing force F1 of the first pressing portion 391 like the cutting portion 91b. Further, the cutting portion 91a is compressed in the direction perpendicular to the inner peripheral surface 371 while receiving a compressing force F3 exerted toward the inside of the punching-out blade 37 from the inner peripheral surface 371.

The cutting portion 91a has a portion that is not pressed between the portion pressed by the first pressing portion 391 and the portion contacting the inner peripheral surface 371 due to the gap d. When the displacement of the cutting surface formed by the intrusion of the blade edge 373 is the same as those of the cutting portions 91a and 91b, the displaceable range of the cutting portion 91a is wide, so that bending easily occurs. A tangential line L of the boundary surface at a position where the cutting portion 91a contacts the inner peripheral surface 371 becomes inclined with respect to the direction perpendicular to the inner peripheral surface 371 as the bending (bending angle) of the cutting portion 91a becomes larger.

The compressing force F3 may be divided into a partial force F5 parallel to the tangential line L and a partial force F6 perpendicular to the tangential line L. The partial force F5 is a shear force that makes the current collector 152 and the electrode active material 153 deviate from each other. The partial force F6 is a force that moves the current collector 152 and the electrode active material 153 close to each other at a portion contacting the inner peripheral surface 371. That is, the partial force F6 is exerted so that the current collector 152 and the electrode active material 153 adhere to each other.

As the inclination of the tangential line L with respect to the direction along the main surface of the original plate 91 increases, the ratio of the partial force F6 with respect to the partial force F5 increases. That is, the partial force F6 increases in accordance with an increase in inclination of the tangential line L. In other words, when the inclination of the tangential line L is set to be a predetermined value or more, the effect of increasing the adhesiveness due to the partial force F6 may be made to be excellent compared to the effect of decreasing the adhesiveness due to the partial force F5. In the embodiment, the gap d is set from this viewpoint, and a degradation of adhesiveness between the current collector 152 and the electrode active material 153 may be prevented during the punching-out process.

Here, the gap d is set to 5 mm or so, and a satisfactory result is obtained in the material of the electrode plate.

Furthermore, the method of making the inclination of the tangential line L become a desired value by setting the gap d to a certain value may be obtained through various numerical simulations or systematic experiments. For example, as a method of estimating the gap d through a simple model, the following method is known. The cutting strength as the upper-limit shear force not cutting the original plate is determined in accordance with the type of the punching-out blade or the mechanical characteristics of the original plate. Regarding a cantilever beam formed of the same material as that of the original plate, a bending angle of the cantilever beam when a force of the cutting strength is applied to the free end is determined by the length of the cantilever beam. Assuming that the deformation of the original plate is the same as that of the cantilever beam, the inclination of the tangential line L corresponds to the bending angle, and the gap d corresponds to the length of the cantilever beam, so that the relationship between the gap d and the tangential line L may be obtained.

The inventor made a punching-out die (which is the same as the punching-out die described in PTL 1) for comparison in which pressing unit comes into contact with both the inner peripheral surface and the outer peripheral surface of the punching-out blade, and compared the difficulty of the separation of the electrode active material with the case of using the electrode plate punching-out device 2 according to the invention. As a result, it was found that the electrode active material was not easily separated from the electrode plate obtained by the electrode plate punching-out device 2 compared to the comparative example. Further, the gap d may be set to 1 mm or more, and when the gap is set to 2 mm or more, the effect of preventing the separation of the electrode active material improves. Further, the gap d may be set to 10 mm or less from the viewpoint of preventing a positional deviation between the original plate and the punching-out blade during the punching-out process, and when the gap is set to 5 mm or less, the effect of preventing the positional deviation improves. In this manner, the gap d may be set to be equal to or more than 1 mm and equal to or less than 10 mm, and more desirably set to be equal to or more than 2 mm and equal to or less than 5 mm.

Furthermore, the technical scope of the invention is not limited to the above-described embodiment. Various modifications may be made within the scope of the spirit of the invention. For example, the electrode plate punching-out device of the invention may be used to punch out any of the positive electrode plate and the negative electrode plate. The punching-out die may be modified as the following first and second modified examples.

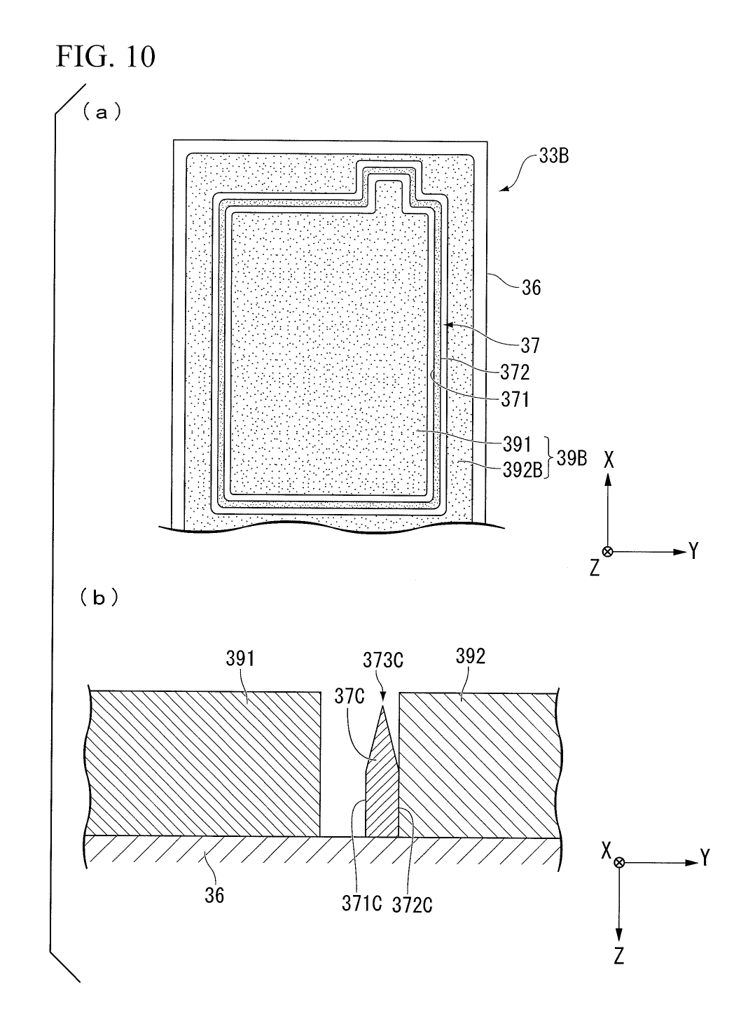

Since a punching-out die 33B of the first modified example shown in FIG. 10(a) is different from that of the above-described embodiment in that a second pressing portion 392B of pressing unit 39B is distant from the outer peripheral surface 372 of the punching-out blade 37. Even when such a punching-out die 33B is used, the electrode active material may be prevented from being separated from the electrode plate. When the second pressing portion 392B is distant from the punching-out blade 37, it is desirable to narrow the gap between the punching-out blade 37 and the second pressing portion 392B compared to the gap between the punching-out blade 37 and the first pressing portion 391 from the viewpoint of reducing a positional deviation between the original plate and the punching-out blade 37 during the punching-out process.

A punching-out blade 37C of the second modified example shown in FIG. 10(b) is different from the above-described embodiment in that the blade includes a double edged blade. In all an inner peripheral surface 371C and an outer peripheral surface 372C of the punching-out blade 37C, the portion directed toward the blade edge 373C is inclined with respect to the direction perpendicular to the main surface of the support substrate 36. Even when such a punching-out blade 37C is used, it is possible to obtain an effect of preventing the separation of the electrode active material by appropriately setting the gap d.

### INDUSTRIAL APPLICABILITY

According to the electrode plate manufacturing device of the invention, it is possible to prevent the electrode active material from being separated from the peripheral edge portion of the electrode plate and improve the manufacturing yield.

### REFERENCE SIGNS LIST

1: ELECTRICAL CELL

2: ELECTRODE PLATE MANUFACTURING DEVICE (ELECTRODE PLATE PUNCHING-OUT DEVICE)

3: DRIVING SYSTEM

10: BATTERY CASING

11: CASING BODY

12: COVER

13, 14: ELECTRODE TERMINAL

15, 16: ELECTRODE PLATE

17: SEPARATOR

20: ORIGINAL PLATE SUPPORT PORTION

20a: TOP SURFACE

21 TO 24: CONVEYING ROLLER

30: CONTROL PORTION

31: DRIVING PORTION

32: HOLDING PORTION

33, 33B: PUNCHING-OUT DIE

34, 35: SUPPORT COLUMN

36: SUPPORT SUBSTRATE (SUBSTRATE)

36a: ARRANGEMENT SURFACE

37, 37C, 38: PUNCHING-OUT BLADE

39, 39B: PRESSING UNIT

90: PROTECTIVE SHEET

91: ORIGINAL PLATE

91a, 91b: CUTTING PORTION

92: FORMATION REGION

93: NON-FORMATION REGION

150: BASE PORTION

151: ELECTRODE TAB

152: CURRENT COLLECTOR

153: ELECTRODE ACTIVE MATERIAL

161: ELECTRODE TAB

371, 371C: INNER PERIPHERAL SURFACE (ONE SURFACE)

372, 372C: OUTER PERIPHERAL SURFACE (THE OTHER SURFACE)

373, 373C: BLADE EDGE

391: FIRST PRESSING PORTION (PRESSING UNIT)

391a: SURFACE OF FIRST PRESSING PORTION

391B: SIDE SURFACE OF FIRST PRESSING PORTION

392, 392B: SECOND PRESSING PORTION (PRESSING UNIT)

392a: SURFACE OF SECOND PRESSING PORTION

392b: SIDE SURFACE OF SECOND PRESSING PORTION

911: CURRENT COLLECTOR

912, 913: ELECTRODE ACTIVE MATERIAL

d: GAP

F1, F2: PRESSING FORCE

F3, F4: COMPRESSING FORCE

F5, F6: PARTIAL FORCE

L: TANGENTIAL LINE

P: PREDETERMINED POSITION

S1 TO S7: STEP

1. An electrode plate manufacturing device comprising:
an original plate support portion that supports an original plate of an electrode plate coated with an electrode active material;
a first pressing portion;
a frame-shaped punching-out blade;
a support substrate, which is disposed to face the original plate support portion, having the first pressing portion and the punching-out blade fixed thereto; and
a driving portion that drives the support substrate to be movable forward and backward with respect to the original plate support portion,
wherein the first pressing portion is disposed in an area inside of the frame shape of the punching-out blade and with a predetermined gap from a punching-out blade cutting the electrode active material, and
wherein the first pressing portion presses the original plate and the punching-out blade cuts the original plate in accordance with the frame shape when the support substrate is advanced toward the original plate support portion by the driving portion.

2. The electrode plate manufacturing device according to claim 1, further comprising:
a second pressing portion that is fixed to the support substrate and is disposed outside the frame shape,
wherein the second pressing portion presses the original plate together with the first pressing portion, when the support substrate is advanced toward the original plate support portion by the driving portion.

3. The electrode plate manufacturing device according to claim 2, further comprising:
a control portion; and
a conveying roller that conveys the original plate through the original plate support portion,
wherein the control portion intermittently operates the conveying roller, and performs the cutting when stopping the conveying roller.

4. The electrode plate manufacturing device according to any claim 1,
wherein the punching-out blade is a single edged Thomson blade.

5. The electrode plate manufacturing device according to claim 2,
wherein the punching-out blade is a single edged Thomson blade.

6. The electrode plate manufacturing device according to claim 3,
wherein the punching-out blade is a single edged Thomson blade.
